(19) United States
(12) Patent Application Publication
(10) Pub. No.: US 2021/0346959 A1
(43) Pub. Date: Nov. 11, 2021

(54) METHOD FOR MANUFACTURING A COMPONENT FOR A SANITARY FITTING

(71) Applicant: LIXIL Corporation, Tokyo (JP)

(72) Inventor: Carsten ROMANOWSKI, Iserlohn (DE)

(21) Appl. No.: 17/278,086

(22) PCT Filed: Mar. 26, 2020
(86) PCT No.: PCT/EP2020/058552

§ 371 Date: Mar. 19, 2021

(30) Foreign Application Priority Data
Mar. 29, 2019 (DE) 10 2019 002 260.2

(51) Int. Cl. B22F 10/28; C22C 1/04; B33Y 10/00; B33Y 70/00; B33Y 80/00

(52) U.S. Cl. CPC B22F 10/28; C22C 1/0425; B33Y 10/00; B22F 2301/30; B33Y 80/00; B22F 2301/10; B33Y 70/00

(57) ABSTRACT

Method for manufacturing a component (1) for a sanitary fitting (2) is proposed, comprising at least the following steps: a. Providing a first metal (3) in powder form, b. Providing a second metal (4) in powder form, the second metal (4) being different from the first metal (3), c. Mixing the metals (3, 4), d. Layer-by-layer construction of the component (1) by partial melting of the metals (3, 4) with a laser (5).

### TECHNICAL FIELD

The present disclosure relates to a method for manufacturing a component for a sanitary fitting, a component for a sanitary fitting and a sanitary fitting.

### BACKGROUND ART

It is known from the state of the art to manufacture sanitary fittings, such as wash basin fittings, bathtub fittings, concealed fittings or the like from brass. Casting processes are generally used for this purpose in order to be able to realize complex geometries, which may also include different functional elements of the fitting.

### SUMMARY

In this connection, however, it could be observed that corresponding casting processes are limited with regard to the quality and accuracy of the geometries and, in particular, their contours that may be achieved with them. This is particularly relevant for particularly thin-walled fittings. In addition, not all freely formable geometries may be realized with appropriate casting processes.

Additive manufacturing processes are also known in which a component is built up or printed layer by layer. The composition and production of specific metallic powders for additive manufacturing are very costly. Larger batches have to be produced metallurgically by melting and then pulverized. In this process, multi-component alloys are produced before powder production. The purity is usually dependent on the melting process. Furthermore, it may be observed that not every composition of multi-component alloy is stable enough for powdering.

On this basis, it is the object of the present disclosure to at least partially solve the problems described with respect to the prior art. In particular, a method for the manufacture of a component of a sanitary fitting, a component for a sanitary fitting and a sanitary fitting should be specified, which help to simplify the additive manufacture of a component for a sanitary fitting.

These objects are solved by the features of the independent claims. Further advantageous embodiments of the solution proposed here are indicated in the dependent claims. It should be noted that the features individually listed in the dependent claims can be combined in any technologically meaningful way and define further embodiments of the invention. In addition, the features indicated in the claims are specified and explained in more detail in the description, with further preferred embodiments of the invention being presented.

A method for manufacturing a component for a sanitary fitting contributes to this, comprising at least the following steps:
a. Providing a first metal in powder form,
b. Providing a second metal in powder form, the second metal being different from the first metal,
c. Mixing the metals,
d. Layer-by-layer construction of the component by partial melting of the metals with a laser.

### BRIEF DESCRIPTION OF THE DRAWINGS

FIG. 1 is a flowchart that illustrates a sequence of the method described here; and

FIG. 2: is an illustration of a possible application of the procedure described here.

### DESCRIPTION OF EMBODIMENTS

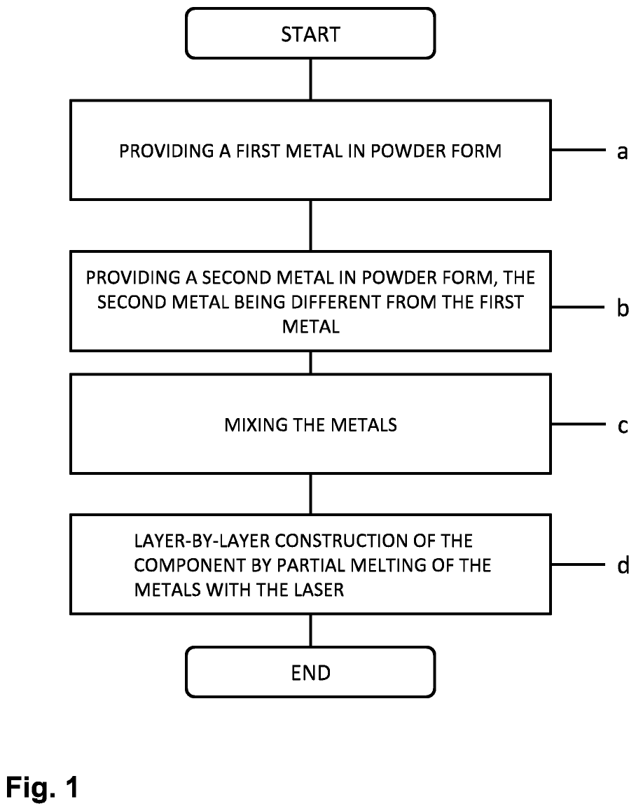

As shown FIG. 1, the order of steps a., b., c. and d. is given as an example and may be used, for example, in a regular operating procedure. In particular, steps a. to d. shall be carried out at least once in the order indicated. Furthermore, steps a. to d., in particular steps a. to c., may also be carried out at least partially in parallel or even simultaneously.

The method may be used, for example, to manufacture a brass component of a sanitary fitting. In particular, the method is used for the (bimetallic) laser sintering of a (brass) housing or (brass) housing part of a sanitary fitting. This method allows brass alloys, for example, to be produced particularly advantageously by using an additive manufacturing process. A particular advantage of the method is that alloy formation takes place (principally) during additive production.

The method described here thus allows the production of multi-component alloys prior to powder production and the subsequent powdering of the multi-component alloys and/or the disadvantages associated with this to be avoided in an advantageous manner. Instead, the alloy may be created in the melt generated by the laser during additive manufacturing. In this context, the powder (mixture) may be mixed together from the purest individual powders. The alloy formation and crystal formation takes place, for example, in the first and repeated melting of the powder mixture. The lower, previously printed layers may be deliberately melted again. Original alloys may thus be produced advantageously. However, it is also possible to add other elements and/or alloys.

In step a. a first metal is provided in powder form. The first metal to be provided in powder form may be a metallic material and possibly also a metal alloy. However, preferably the first metal to be provided in powder form is a pure metal (i.e. not an alloy). In this context, the first metal may be a copper powder, for example.

In step b. a second metal is provided in powder form, the second metal being different from the first metal. In this context, metals differ not only in their material properties such as hardness or melting point. Rather, the metals usually differ in their chemical elements. The second metal to be provided in powder form may be a metallic material and possibly a metal alloy. Preferably, however, the second metal to be provided in powder form is a pure metal (i.e. not an alloy). In this context, the second metal may be, for example, zinc powder or silver powder.

In step c. the metals are mixed. Mixing may take place, for example, before and/or during the provision of the two metals. Alternatively or cumulatively, mixing may also take place during and/or after the provision of the two metals. The mixing of metals in a powder bed or to a powder bed is particularly preferred. In step c. a powder mixture of two metals with clearly different melting points is usually produced. Furthermore, the two metals may have limited or complete solubility in the liquid state. In this context, the mixing of different metal powders may also be done deliberately in the whole grain diameter range of powder bed printers. In particular, multi-metal mixtures may be produced as pure and/or exact as possible.

In step d. the component is built up layer by layer by partial melting of the metals with a laser. Layer-by-layer construction may also be described in such a way that several layers are formed one after the other, on top of each other or layer by layer. A layer essentially describes a horizontal cross-section through the component. In particular, an alloy comprising the first metal and the second metal (with their respective typical phases and crystal structures) is formed during melting in step d.

In partial melting, the powder located within a layer is heated locally, at predetermined points at which material solidification is to occur, for as long and/or as intensively as necessary so that the metal powder grains there (briefly) liquefy and thus bond permanently (or until reheating). Partial melting may be carried out advantageously in the form of 3D printing (in a powder bed) or in the form of a three-dimensional, additive manufacturing process (in a powder bed and/or with laser melting).

Preferably, laser sintering and/or laser melting is performed in step d. In step d. a so-called selective laser sintering (short: SLS) is particularly preferred. Selective laser sintering (SLS) is an additive manufacturing process for producing spatial structures by sintering with a laser from a powdered raw material. Alternatively or cumulatively, a so-called selective laser melting (short: SLM) may be performed in step d.

Preferably, the laser power(s) and/or the melting temperature(s) and/or the exposure time(s) of the laser are selected and/or controlled in such a way that, on the one hand, there is enough time for a molten mixing of the different metals and, on the other hand, the time is short enough to avoid segregation if possible. The (maximum) cooling rate should be less than 10⁶ K/s [Kelvin per second]. Preferably, the cooling rate is in the range of 20 K/s to 2,000 k/s. With regard to the melting temperatures, the following ranges are preferred depending on the metal to be processed: for Cu greater than 1,100° C., for Zn greater than 450° C., for stainless steel greater than 1,500° C., for uZn (remelted Zn) greater than 900° C. Particularly through a short melting time, materials with very different melting points may be advantageously alloyed together.

According an advantageous embodiment, it is suggested that a powder bed is formed in step c. This allows a particularly simple and controlled supply of the powders in an advantageous way. In this context, the method may also be described in particular as bimetal laser sintering in a metal printer with a powder bed.

Following another advantageous embodiment, it is proposed that in step d. at least partial bonds are generated between several powder grains of the first metal and the second metal. In this context, the laser parameters and/or the exposure strategies may be set in such a way that the powder spheres of the different (pure) materials, which usually have different melting points, partially bond with each other (in a targeted or controlled manner).

Following another advantageous embodiment, it is proposed that in step d. at least partial bonds are made between several powder grains of the first metal from a first layer and the second metal from a second layer adjacent to it (i.e. to the first layer). This may contribute to a particularly advantageous cross-linking within the alloy. The lower, previously printed beds (layers) may be deliberately melted again.

According another advantageous embodiment, it is proposed that in step d. at least partially an alloy with (or from) the first metal and the second metal is produced. The method may be used to produce the finest alloys in particular. In addition, alloys that are not stable in casting or other melting processes may be produced in an advantageous way. For example, the alloy may be a brass alloy.

According another advantageous embodiment, it is proposed that the first metal has a first melting point and the second metal has a second melting point, the second melting point being lower than the first melting point. In other words, this means that the second melting point is below the first melting point.

Following another advantageous embodiment, it is proposed that a copper-based material be used as the first metal and a zinc-based material as the second metal. This may contribute in a particularly advantageous way to the additive production of a brass component for a sanitary fitting.

According a further advantageous embodiment, it is suggested that at least the first metal or the second metal is a metal alloy. This may be used in particular to adjust the properties of the metal alloy partially or locally (targeted and/or controlled).

For example, the addition of silver powder (e.g. as tiny particles in a copper powder alloy) may be used to provide bacterial protection. In this context, the first metal may be, for example, a brass powder and/or copper-based alloy powder and the second metal may be, for example, a silver powder.

According to another aspect, a component for a sanitary fitting is also specified, whereby the component is manufactured using a method described here. The component may be a housing or a housing part of a sanitary fitting, for example.

According to another aspect, a sanitary fitting comprising a component manufactured using a method described here is also specified. In this context, the sanitary fitting may also have a component described here. The sanitary fitting may be, for example, a washbasin fitting, bathtub fitting, concealed fitting or the like.

The details, features and advantageous embodiments discussed in connection with the method may also occur in the component and/or sanitary fitting presented here and vice versa. In this respect, full reference is made to the explanations there concerning the further characterization of the features.

The solution presented here as well as its technical environment will be explained in more detail in the following using the figures. It should be pointed out that the disclosure is not to be restricted by the examples shown. In particular, unless explicitly stated otherwise, it is also possible to extract partial aspects of the facts explained in or in connection with the figures and combine them with other features and/or findings from other figures and/or the present description. It shows exemplary and schematic:

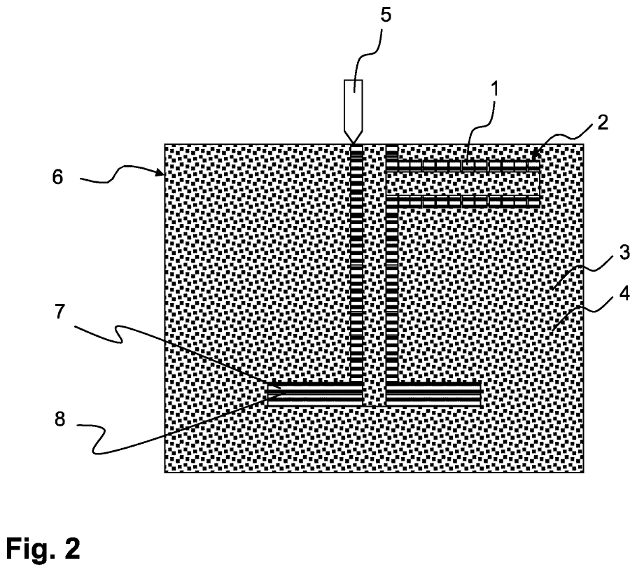

FIG. 2 shows an exemplary and schematic illustration of a possible application of the method described here.

To produce component 1 of a sanitary fitting 2, a first metal 3 in powder form and a second metal 4 in powder form, which differs from the first metal 3, are mixed together to form a powder bed 6.

Subsequently, component 1 is built up layer by layer by partial melting of metals 3, 4 with a laser 5, which allows at least partial bonding between several powder grains of the first metal 3 and the second metal 4. In particular, it is also possible to produce at least partial bonds between several powder grains of the first metal 3 from a first layer 7 and the second metal 4 from a second layer 8 adjacent to it.

During the layer-by-layer build-up, an alloy is created with the first metal 3 and the second metal 4. For example, the first metal 3 has a first melting point and the second metal 4 a second melting point, whereby the second melting point is lower than the first melting point.

For example, the first metal 3 is a copper-based material and the second metal 4 is a zinc-based material. Alternatively or cumulatively, a metal alloy may be used as the first metal 3 and/or as the second metal 4. However, preferably at least one of the metals 3, 4 is a pure metal.

An advantage of the method may be seen here in particular in the fact that the production of pure powders is much easier than the production of powders from alloys. Pure zinc powder and pure copper powder, for example, are much easier to produce than brass powder.

Thus, a method for manufacturing a component of a sanitary fitting, a component for a sanitary fitting and a sanitary fitting are specified here, which at least partially solve the problems described with reference to the state of the art. In particular, a method for manufacturing a component of a sanitary fitting, a component for a sanitary fitting and a sanitary fitting are specified, which help to simplify the additive manufacturing of a component for a sanitary fitting.

1. A method for manufacturing a component for a sanitary fitting, comprising: a. Providing a first metal in powder form;
b. Providing a second metal in powder form, the second metal being different from the first metal;
c. Mixing the metals; and
d. Layer-by-layer construction of the component by partial melting of the metals with a laser.

2. The method according to claim 1, wherein a powder bed is formed in step c.

3. The method according to claim 1, wherein in step d. bonds are at least partially produced between a plurality of powder grains of the first metal and the second metal.

4. The method according to claim 1, in which in step d. at least partial bonds are produced between several powder grains of the first metal from a first layer and the second metal from a second layer adjacent thereto.

5. The method according to claim 1, wherein in step d. at least partially an alloy is produced with the first metal and the second metal.

6. The method according to claim 1, in which the first metal has a first melting point and the second metal has a second melting point, the second melting point being lower than the first melting point.

7. The method according to claim 1, in which a copper-based material is used as the first metal and a zinc-based material as the second metal.

8. The method according to claim 1, in which at least as first metal or as second metal a metal alloy is used.

9. Component for a sanitary fitting, wherein a component is manufactured by a method comprising:
a. Providing a first metal in powder form;
b. Providing a second metal in powder form, the second metal being different from the first metal;
c. Mixing the metals; and
d. Layer-by-layer construction of the component by partial melting of the metals with a laser.

10. A sanitary fitting comprising a component manufactured by a method comprising:
a. Providing a first metal in powder form;
b. Providing a second metal in powder form, the second metal being different from the first metal;
c. Mixing the metals; and
d. Layer-by-layer construction of the component by partial melting of the metals with a laser.

11. The component for the sanitary fitting according to claim 9, wherein a powder bed is formed in step c.

12. The component for the sanitary fitting according to claim 9, wherein in step d. bonds are at least partially produced between a plurality of powder grains of the first metal and the second metal.

13. The component for the sanitary fitting according to claim 9, in which in step d. at least partial bonds are produced between several powder grains of the first metal from a first layer and the second metal from a second layer adjacent thereto.

14. The component for the sanitary fitting according to claim 9, wherein in step d. at least partially an alloy is produced with the first metal and the second metal.

15. The component for the sanitary fitting according to claim 9, in which the first metal has a first melting point and the second metal has a second melting point, the second melting point being lower than the first melting point.

16. The component for the sanitary fitting according to claim 9, in which a copper-based material is used as the first metal and a zinc-based material as the second metal.

17. The component for the sanitary fitting according to claim 9, in which at least as first metal or as second metal a metal alloy is used.

18. The sanitary fitting according to claim 10, wherein a powder bed is formed in step c.

19. The sanitary fitting according to claim 10, wherein in step d. bonds are at least partially produced between a plurality of powder grains of the first metal and the second metal.

20. The sanitary fitting according to claim 10, in which in step d. at least partial bonds are produced between several powder grains of the first metal from a first layer and the second metal from a second layer adjacent thereto.
